(19) United States
(12) Patent Application Publication
(10) Pub. No.: US 2016/0339337 A1
(43) Pub. Date: Nov. 24, 2016

(54) RETROREFLECTIVE SURFACE WITH INTEGRATED FIDUCIAL MARKERS FOR AN AUGMENTED REALITY SYSTEM

(71) Applicant: CastAR, Inc., Palo Alto, CA (US)

(72) Inventors: Jeri J. ELLSWORTH, San Jose, CA (US); Carroll Philip GOSSETT, Mountain View, CA (US); Ken CLEMENTS, Los Gatos, CA (US)

(21) Appl. No.: 15/160,996

(22) Filed: May 20, 2016

Related U.S. Application Data
(60) Provisional application No. 62/165,089, filed on May 21, 2015.

(51) Int. Cl. A63F 13/25; G02B 5/136; G02B 27/34; G02B 27/01

(52) U.S. Cl. CPC A63F 13/25; G02B 27/017; G02B 5/136; G02B 27/34

(57) ABSTRACT

A retroreflective surface is described in which embedded tracking fiducial information is encoded by spatial patterns, the patterns providing modulation of characteristics of reflected light of selected wavelengths.

### CROSS REFERENCE TO RELATED APPLICATIONS

The present application claims the benefit of U.S. Provisional application No. 62/165,089, the contents of which are hereby incorporated by reference.

### FIELD OF THE INVENTION

The present invention is generally related to fiducial tracking markers used with retroreflective screens in head mounted projected display (HMPD) systems. More particularly, an embodiment of the present invention is directed to fiducial markers integrated into a retroreflective screen of an augmented reality system.

### BACKGROUND OF THE INVENTION

FIG. 1 shows a prior art configuration in which a head mounted projected display (HMPD) unit 101 receives through its tracking image sensor 102 the image of a tracking fiducial 103, which comprises a pattern of active point light sources 104, such as arrays of light emitting diodes. Typically, infrared light emitting diodes (IRLED) are used for these light sources, and are placed in a fixed pattern to form the fiducial. Near infrared is typically used so that the fiducials are not seen by the user as a distraction from the projected images. The HPMD may, for example, be similar to that described in US Patent Publication 2014/034024 and further include one or more image projectors to project computer generated images (CGI) 106 (illustrated as a flying bird in FIG. 1 for the purposes of illustration). Additional view lenses and optics in the HMPD provide separate images to each eye and may be provided to create an augmented reality experience in which the user perceives the retroreflected images and may also interact with objects in the real world.

The tracking fiducial 103 is placed in the environment of the retroreflective screen 105 such that when the user makes head movements, the system is able to use the changing fiducial image received by the tracking image sensor 102 to calculate the position and pose of the HMPD with regard to the position and pose of the observed fiducial. Based on this position information, the system is able to calculate a render view of a CGI object 106 that is to be projected according to well known augmented reality art.

Referring to FIG. 2, in many cases, the tracking fiducial 103 is a block shaped unit having a battery compartment to power the LED active point light sources 104. Thus, the tracking fiducial 103 is an additional unit having a thickness consistent with a battery compartment sized to house a battery having a reasonable lifetime. The tracking fiducial 103 is thus generally an extra unit in the overall system design. Additionally, the fact that the active fiducials require a power source is inconvenient. For example, in the context of an augmented reality game the battery of the tracking fiducial may wear down during a gaming session and is an extra unit that must be brought along.

There is also another problem with the tracking fiducial 103. In the example of FIG. 1, the tracking fiducial 103 is offset from the projected image 106. That is, the tracking fiducials are often at a side position offset with respect to the projected image 106. This position is not optimal to return a good tracking image. Additionally, in some applications a physical object may occlude part or all of one or more of the active fiducials 104. In the example of FIG. 1, a game piece 107 is illustrated. The game piece 107 may, for example be a token or game piece that is a real physical object. Thus object 107 may be in a position with respect to the tracking fiducial and the HMPD unit 101 that it blocks one or more of the active fiducials 104. This can be a drawback in the context of an augmented reality game in which some of the components of the game may be physical objects, such as game tokens, and other objects may be computer generated.

### SUMMARY OF THE INVENTION

An apparatus, system, and method is disclosed for integrating the fiducial marking function into the retroreflective surface that is used in a head mounted projected display (HMPD) system. The fiducial markers may be implemented as passive fiducial markers that do not require battery power or an external power source. In one embodiment, a fiducial marker pattern is embedded in a retroreflective surface or in a boundary region thereof, so that the pattern can be identified by illumination from the HMPD (or other source). In one embodiment the fiducial marking pattern comprise fluorescent regions. In another embodiment, the fiducial markers comprise regions of variable absorption in a non-visible wavelength band, such as infrared or ultraviolet. In an alternate embodiment, energy is harvested, such as through an integrated antenna, to power active emitters as the fiducial markers.

The design of the HMPD may include consideration of the arrangement of the fiducial markers and other characteristics of the operation of the passive fiducial markers, such as whether the HMPD is to provide a pumping illumination. The operation of the HMPD and the arrangement of the fiducial markers may also be selected to avoid adding artifacts to the display images also projected by the HMPD. An exemplary application is disclosed for augmented reality games, although embodiments of the present invention are not limited to gaming applications.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a HMPD with active battery powered fiducial markers offset from the main retroreflective screen in accordance with the prior art.

FIG. 2 illustrates in more detail the tracking fiducial block of FIG. 1.

FIG. 3 illustrates a system including a HMPD and a retroreflective screen with integrated passive fiducials in accordance with an embodiment.

FIG. 4 illustrates a method of designing the system of FIG. 3.

FIG. 5 illustrates an embodiment of a retroreflective screen having passive fluorescent fiducials disposed in a border region.

FIG. 6 illustrates an embodiment having a retroreflective screen that is reflective for visible light but which has a spatial variation in infrared absorption over the two-dimensional surface of the retroreflective screen.

FIG. 7A illustrates an alternate embodiment having active emitters powered by harvesting electromagnetic energy via an embedded antenna.

FIG. 7B illustrates an alternate embodiment having active emitters power by harvesting optical energy.

FIG. 8 illustrates an embodiment of a method of operating a HMPD with a retroreflective screen with integrated fiducials.

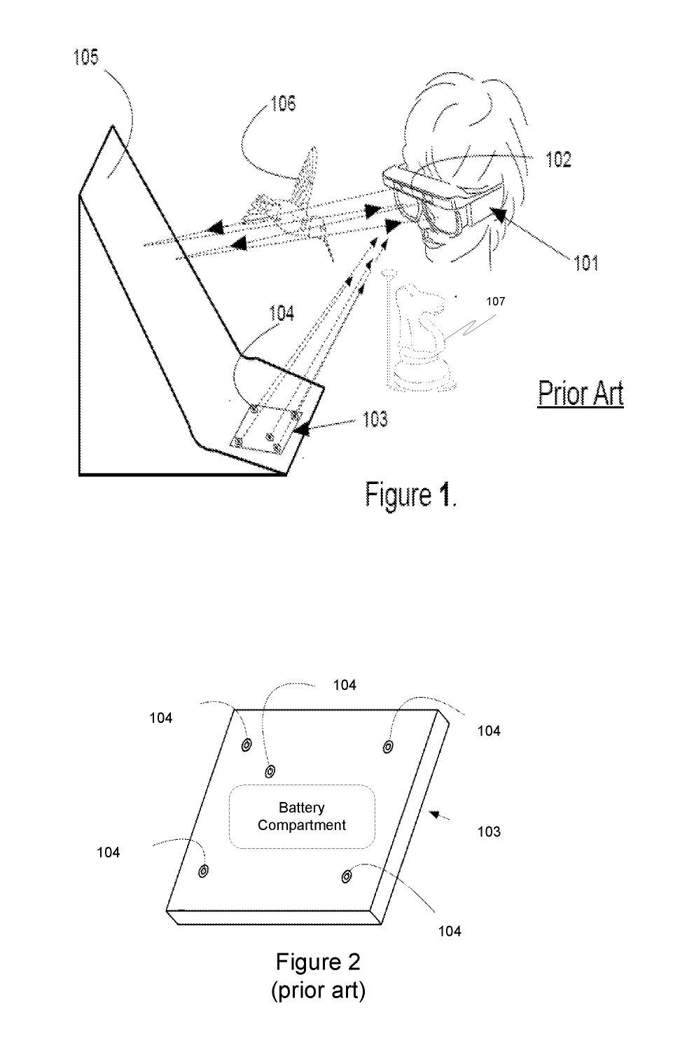

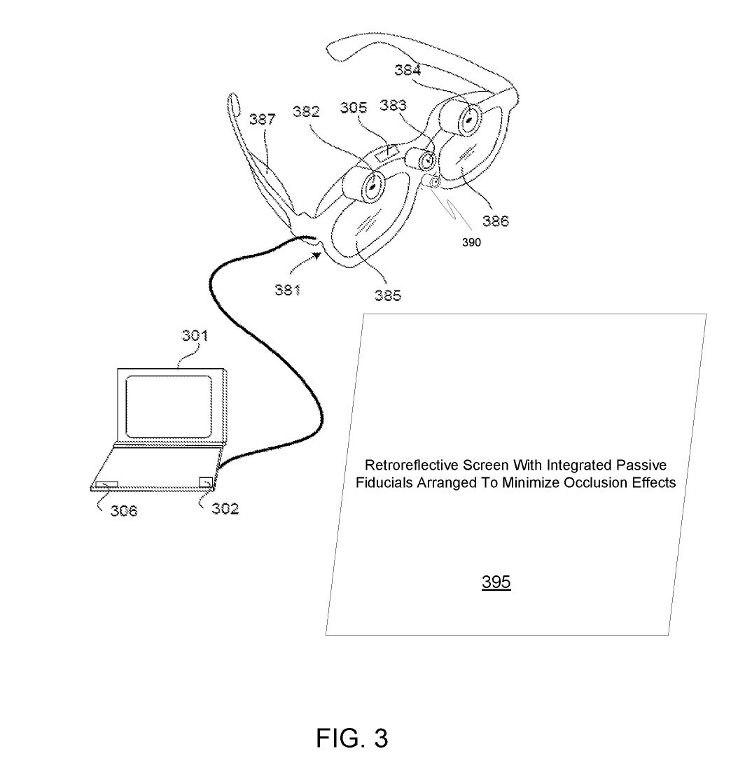

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

### DETAILED DESCRIPTION

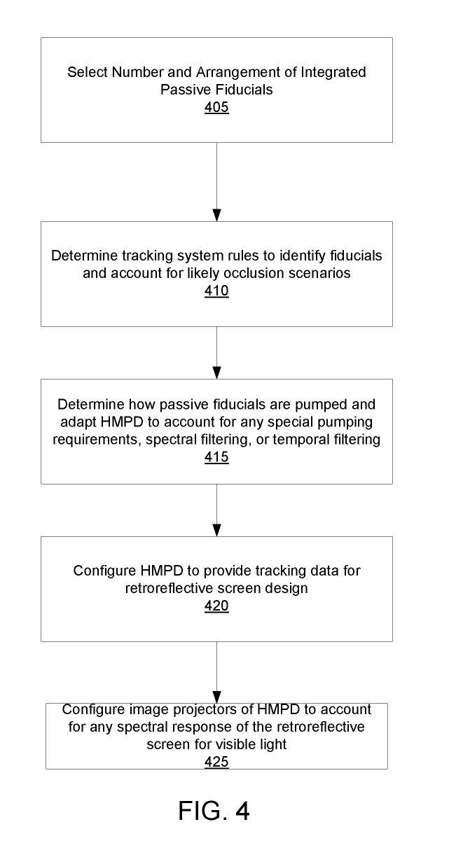

Referring to FIG. 3, in one embodiment of a system HMPD 381 includes a tracking module 383 to track the position of the user. The tracking module 383 may be mounted to a portion of the frame 387 along with one or more image projectors 382, 384 and polarizing lenses 385, 386, and control electronics 305 in the HMPD. A computer 301 with a CPU 306 and GPU 302 may be used to generate images for the HMPD and receive the tracking data from the tracking module 383.

The projected optical images returned to the HMPD must be isolated from the returning fiducial information. Many techniques are available to achieve this isolation, such as isolation by spatial position, wavelength or polarization, etc.

In one embodiment, a retroreflective screen 395 has integrated fiducials arranged to provide fiducial information for tracking module 383 to track the position and movement of the HMPD 381. The integrated fiducials do not require an external battery or wall plug power and hence are passive.

The integrated fiducials may be implemented in a variety of ways. In one embodiment the integrated fiducials comprise fluorescent dots or fluorescent regions that are pumped by ambient light or by a pump source. In one embodiment, the HMPD 381 includes an infrared pumping source 390 to pump fluorescent fiducial markers that may be disposed in a portion of the retroreflective screen 395, such as in a border region. In one embodiment, the integrated fiducials comprise regions having a spatial variation in a non-visible wavelength band, such as an infrared wavelength band or an ultraviolet wavelength band. This permits a retroreflective surface to reflect light from the image projectors 382, 384 while also generating a fiducial pattern that can be detected by the tracking module 383 observing the spatial variation of light in the non-visible wavelength band. More generally, the integrated fiducials could harvest electromagnetic energy, such as via an integrated antenna or solar cell, and power active emitters with that harvested energy, such as LEDs.

Eliminating the need for a battery or external power for the fiducial markers reduces the number of different components a user needs to trouble-shoot and eliminates the need to provide batteries for the fiducial marking function.

Additionally, in one embodiment, integrating the fiducials in the retroreflective screen may include optimizing the number and arrangement of fiducial markers to facilitate tracking. The selection of the spatial distribution of fiducials throughout the retroreflective surface may be performed such that a fiducial tracking pattern is in view of even narrow field sensors, and still functional even if some individual fiducial markers are occluded. For example, in a gaming environment, the retroreflective screen 395 may be used to play an augmented reality game. As such, the rules of the game, the size of the retroreflective screen, and typical ranges of distance and angles of the user from the retroreflective screen during game play may be used to determine a spatial distribution of fiducials that provides tracking information even when a game piece or a portion of a user's body occludes some of the fiducials. For example, the fiducials may be distributed over one or both dimensions of the retroreflective screen. Additionally, the distribution of fiducials may take into account any tokens or other physical objects used in game play.

The individual fiducial markers do not have to be invisible but preferably do not distract from the user experience. In some cases, it is desirable that the fiducial markers are nearly or completely invisible to the user in the sense that they do not overly distract from providing CGI images to the user. The hiding of the fiducial markers can include techniques used in other fields outside of augmented reality. For example, there are techniques to at least partially hide visual tags in retroreflective materials. (See, e.g., U.S. Pat. No. 7,387,393 “Methods for producing low-visibility retroreflective visual tags” and US 2012/200,710 “Prismatic retroreflective sheeting with reduced retroreflectivity of infra-red light” for examples of hidden IR tags, the contents of which are hereby incorporated by reference.)

The tracking module 383 may, for example, include at least one camera to take images and detect the integrated fiducial markers. The tracking module 383 in some embodiments includes temporal and/or spectral filters. For example, in embodiments in which the HMPD 381 has an infrared pump source 390, a spectral filter may be included to filter out reflected pump light while allowing a camera to receive light within a spectral band emitted by the passive integrated fiducial markers. The temporal filtering may, for example, comprise flashing the pump source 390 and detecting fluorescent fiducial markers in time windows when the pump source 390 is off and the fluorescent fiducial markers are fluorescing. It will also be understood that the tracking module 383 is adapted to account for the arrangement of passive fiducial markers. For example, if retroreflective screen has, say 10 integrated fiducial markers then the arrangement of those 10 integrated fiducial markers may be taken into account in making tracking decisions.

The tracking module 383 may perform tracking and range finding to determine, for example a distance to the retroreflective screen and the position of the user's head. The tracking of the user's head and or eye tracking means, and rendering software, permits the production of images of CGI objects with focal depth and perceptual presence. Furthermore, cameras and range finding in the tracking module facilitates software analysis of the shapes and positions, etc., of real objects in view, so as to mix CGI objects at corresponding focal plane distances with real objects in what is known in the art as “mixed reality.” In particular, the tracking data may be provided to be used during CGI image generation to generate augmented reality images. In augmented reality, a user has a view of real objects and the retroreflected projected images provide the augmented reality.

An exemplary application is that retroreflective screen 395 is implemented as a game mat or game board. In a game mat/game board application the retroreflective screen may, for example, be sized to fit on a desk or table. In one embodiment, the retroreflective screen may optionally be implemented as a flexible unit that may be folded or rolled into a compact shape. However, it will be understood that the retroreflective screen may be designed for other applications, such as business applications, and oriented differently than that illustrated, such as to have a vertical orientation.

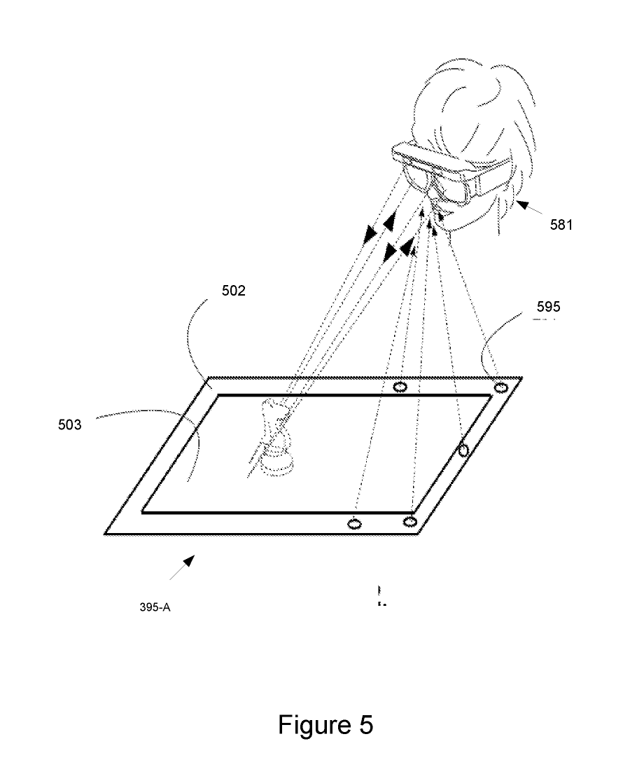

FIG. 4 illustrates a method of designing an HMPD and retroreflective screen in accordance with an embodiment. In designing a system, the number and arrangement of integrated fiducial markers is selected 405. Tracking system rules may be determined 410 to identify the fiducial markers and generate tracking data based on their number and arrangement. Additionally, rules may be included to account for likely occlusion scenarios. For example, in a game application, the user's vision will likely be centered on a central portion of game region of the retroreflective screen and the fiducial markers may be arranged to facilitate receiving tracking data, reducing the potential for occlusion, and adapting to any partial occlusion.

A determination is made 415 as to whether and how the passive fiducials are pumped and any adaptations required by the HMPD. Part of the operation of the system is determined by whether or not the HMPD includes a pumping source 390 to pump passive fluorescent fiducials. For example, the fiducial markers may comprise fluorescent dots that require at least some infrared pumping. Thus, if the HMPD needs to generate a pump illumination (e.g., one or more bands of infrared light) then the HMPD control electronics 305 need to be configured to generate pumping signals to pump source 390. While static pumping is possible, more generally pulsed pumping may be performed in which the pump source 390 is briefly flashed and then the fluorescent dots fluoresce. Temporal filtering may also be included in the tracking module to pump the fluorescent dots and to collect tracking data at other times. Additionally, if desired, other aspects of the HMPD may also be coordinated with any pumping. As another consideration in design, spectral filtering may be included to reject reflected pump light. The HMPD is configured 420 to provide tracking data for the retroreflective screen design. In some embodiments, the integration of passive fiducial markers into a main region of a retroreflective screen may create some optical ab-sorption of visible light with a wavelength dependence. In one embodiment the response of the image projectors 382, 384 are adapted to account for the spectral response of the retroreflective screen.

In a more general case, a HMPD may be designed to operate for a range of different retroreflective screen designs and then a setup procedure used to select operation for a particular screen design. For example, a given HMPD design could support a set of different retroreflective screen design options in terms of the integrated fiducial arrangement and pumping scenarios (e.g., pumping provided by the HMPD or no pumping).

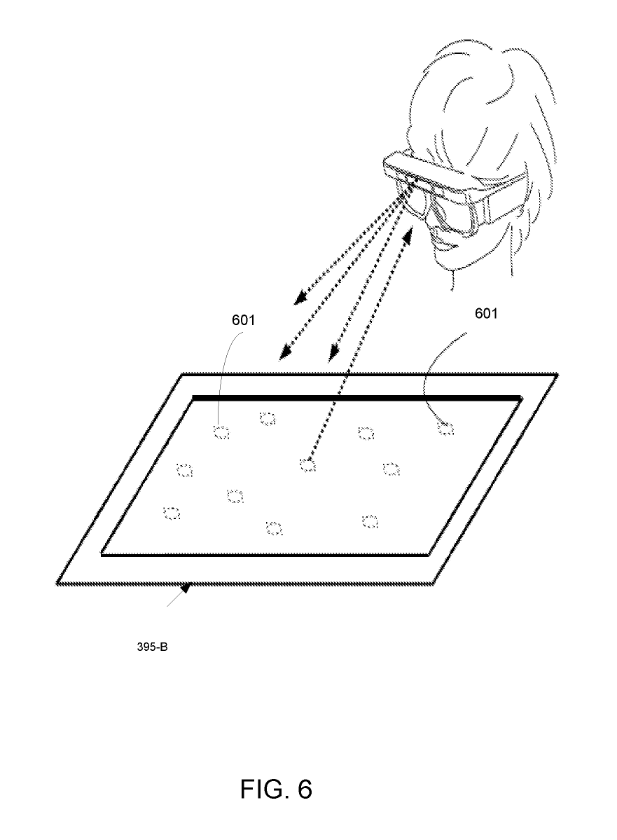

FIG. 5 illustrates an embodiment in which the integrated passive fiducial markers are arranged as a set of dots 595 on an outer border region 502 of a screen 395-A. In the example of FIG. 5, five dots are arranged on a non-reflective 502 border, although it will be understood that different numbers of dots may be used. As an example, the dots 595 of fiducial markers may be formed by brightly painted or retroreflective dots placed in a nonreflective border 502 about a central retroreflective surface 503 (or alternatively may be embodied by nonreflective dots in a reflective border). The embodiment of FIG. 5 has the advantage that the fiducial markers require no power source, and may be illuminated by either ambient light, or projected illumination from the HMPD 581, or both. This arrangement is particularly suited to applications such as augmented board games in which there is usually a board play area that can be made retroreflective and a border to that area that is out of game play.

In one implementation the dots 595 comprise a fluorescent material that harvests energy either from ambient light or from illumination by the HMPD. IR fluorescent markers may be pumped by either a shorter (the usual case) or longer (unusual but possible) wavelength illumination. The glare from illumination may be reduced by offset of wavelength between illumination and fluorescent return. For example, a HMPD might use a wavelength of 740 nm to pump fluorescence of dots at, 980 nm and use a narrow 980 nm filter on the camera of the tracking module to exclude the 740 nm illumination bouncing back from the retroreflective return on the game board.

Fiducial markers near or on a retroreflective background may suffer when illuminated by the glare returned by that background. This difficulty may be greatly relieved by using markers that fluoresce in the near infrared spectrum when actively illuminated or pumped prior to optical or video sampling. This technique prevents the glare from the retroreflective background by using a quick flash of illumination and then photographing or video sampling the state of the fiducial marks when the illumination has finished pumping, but while the fluorescent markers are still emitting light.

Furthermore, in some game applications, this arrangement directs the user's view predominately to the center of the game board, allowing a narrow field of view sensors of the tracking module 383 to be used to track the fiducial markers located in the border. The fiducial markers may also be covered with lenses to give them wider optical field angles, or may allow them to be made very small as is used in Bokode technology (See, e.g., “Bokode: Imperceptible Visual tags for Camera Based Interaction From a Distance,” by Mohan et. al, ACM Transactions on Graphics, Proceedings of ACM SIGGRAPH 2009, Volume 28, Issue 3, (2009), the contents of which are herby incorporated by reference). Covers that pass only infrared light may be used to hide these fiducial markers along the border or in other non-retroreflective areas.

In another embodiment, the retroreflective surface is modified to be retroreflective for visible light but to have a spatial variation in an optical characteristic, over the two-dimensional surface of the retroreflective screen, for a non-visible wavelength band, such as an infrared light band or an ultraviolet wavelength band. That is, the two dimensional surface of the retroreflective screen can be further analyzed as a set of two-dimensional sub-regions. An optical characteristic (e.g., optical loss) in a non-visible wavelength band may be designed to be different from one sub-region to another to form fiducial markers. For example, a two-dimensional sub-region with a higher optical loss in a non-visible wavelength band may correspond to a sub-region used as a fiducial marker. This can be implemented in a variety of ways. In one embodiment, an additional layer or film is placed over the retroreflective surface. However, more generally, the retroreflective surface could be modified to have a spatial variation in a spectral characteristic (e.g., absorption) of a non-visible wavelength band.

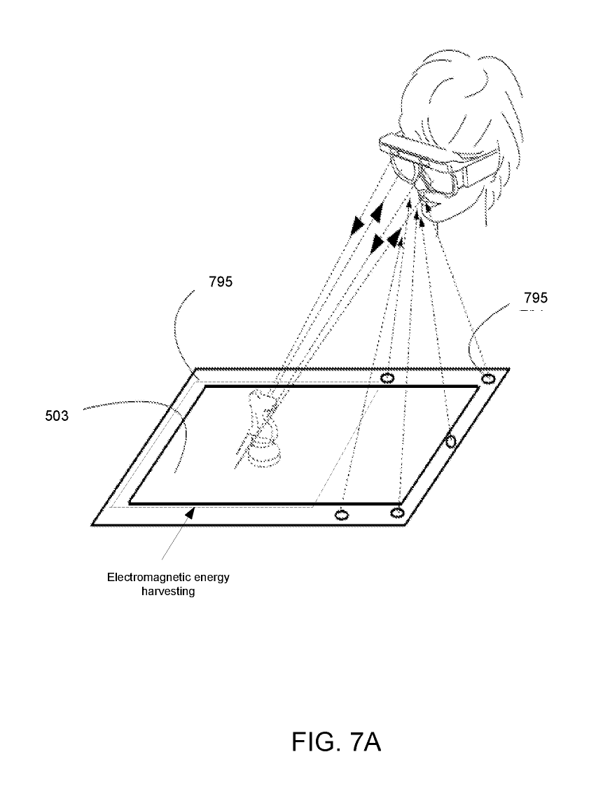

FIG. 6 shows an embodiment in which the fiducial marker pattern 601 (shown as dots but which may be embodied in other configurations) is layered on the surface of a retroreflective screen 395-B through the use of special inks or films that pass the visible spectrum of light but which absorb infrared light. Thus a spatial variation in infrared absorption is formed over a range of wavelengths. Examples of suitable materials include those taught in US 2008/192,233 “Near infrared electromagnetic radiation absorbing composition and method of use” or films as in U.S. Pat. No. 7,018,714 “Near-infrared absorption film”) that selectively absorb near infrared light. In the embodiment of FIG. 6, the retroreflective screen is thus retroreflective for the visible spectrum of light but block infrared light from reaching the retroreflective surface and being retroreflected. As a result, the retroreflective screen has fiducial markers for infrared light. In one embodiment, the inks are chosen to pass as much of the visible spectrum as possible while blocking the infrared from reaching the retroreflective surface and being reflected. In general, it is typically not advisable to print inks directly on the retroreflective material because this often interferes with the optical properties, however, it is possible to print the inks on a thin transparency that can be used to cover the retroreflective screen as taught in U.S. Pat. No. 6,157,486 “Retroreflective dichroic reflector” and U.S. Pat. No. 6,296,188 “Transparent/translucent financial transaction card including an infrared light filter,” the contents of which are herby incorporated by reference.

In some embodiments the inks may partially absorb some amount of the visible spectrum, especially in the blue range, and it may be necessary to boost the brightness of these wavelengths in the HMPD itself to bring the color balance of the reflected image back into correct values. Thus, in addition to other considerations, the operation of the cameras 382 and 384 of the HMPD may be adapted to account for any additional optical absorption of visible light caused by integrating the fiducial markers in the retroreflective screen. As the fiducial markers comprises dots or other shapes printed on transparency, if this visible absorption is noticeable, it may be necessary to print the reverse image on the transparency with other inks that present the same visible absorption (thus giving a uniform surface without visible pattern) but without near infrared absorption.

There are other techniques that may be used to create a spatial variation in an infrared signal from a surface that is retroreflective for visible light. An alternate to using IR absorbing inks may be to use a layer of transparent material on the surface of the retroreflector that varies in thickness so as to be transparent to all visible wavelengths but having dot or other shaped areas that are thinned to present destructive interference for the specific wavelength of infrared light illuminated from the HMPD. A similar effect may be achieved by using layers that have polarizing filters that reject the infrared illumination from the HMPD if oppositely orientated, but pass the light if over the fiducial markers (applicable to systems that use monovision or use techniques other than polarization to separate the visual fields for stereovision). It will also be understood that similar technique could be applied for an ultraviolet wavelength band.

Another alternative implementation is to print or emboss a diffraction pattern (or photographically produce a hologram) that has a line spacing too wide to significantly diffract the wavelengths of the visible spectrum, but that does diffract the projected near infrared illumination wavelength so as to form the spatial modulation pattern of the distributed fiducials. (See U.S. Pat. No. 4,036,552 “Retroreflective material made by recording a plurality of light interference fringe patterns”, the contents of which are hereby incorporated by reference)

While means to intercept near infrared light as it hits the retroreflective surface have been discussed, it is also possible that embodiments may include spatially varying a material property of the retroreflective material itself to provide an equivalent spatial variation in a non-visible wavelength band. In the case of retroreflective sheeting comprising reflective spherical particles, some spheres may be coated with dielectric layers that reject retroreflection at specific wavelengths as taught in U.S. Pat. No. 6,978,896 “Method of making retrochromic beads and kit thereof”, the contents of which are hereby corporate by reference. The fabrication of such screen may be done by printing the screen with special spheres that do not reflect the near infrared light in the places of the fiducial markers, and with noncoated spheres everywhere else on the surface. This produces a screen that is retroreflective to the visible projection everywhere, but is only retroreflective to the illuminated infrared light in the areas with the noncoated spheres.

Another class of retroreflective screens with a spatial variation in optical characteristics of the retroreflective screen may be formed from tessellated cube corners as taught in U.S. Pat. No. 3,712,706 “Retroreflective surface.” These arrays may be prismatic or hollow corners. As described above, these may be covered with transparencies or films that selectively block near infrared so as to display the distributed fiducial pattern when illuminated with IR light, or selected hollows partially filled with wavelength absorbing materials. These arrays are typically made by molding or embossing plastic sheet and then the sheet is subjected to further steps of adding reflective coatings. In the molding or embossing process, an embodiment of the present invention apply a first diffraction pattern to the mold or embossing master such that the pattern is transferred to the reflective surfaces of the prisms or hollows. By this means no ink or printing is needed to add the near infrared selectivity to the surface.

A retroreflective surface may also be manufactured by molding or embossing in which a first converging lens is formed on a surface and a concave mirror is formed on the facing back second surface as taught in U.S. Pat. No. 7,978,321 “Angle measurements”, the contents of which are hereby incorporated by reference. An embodiment of the present invention may be embodied by transferring a diffraction pattern during the molding or embossing process, with the pattern acting to selectively redirect near infrared illumination, as described above for the case of corner reflectors.

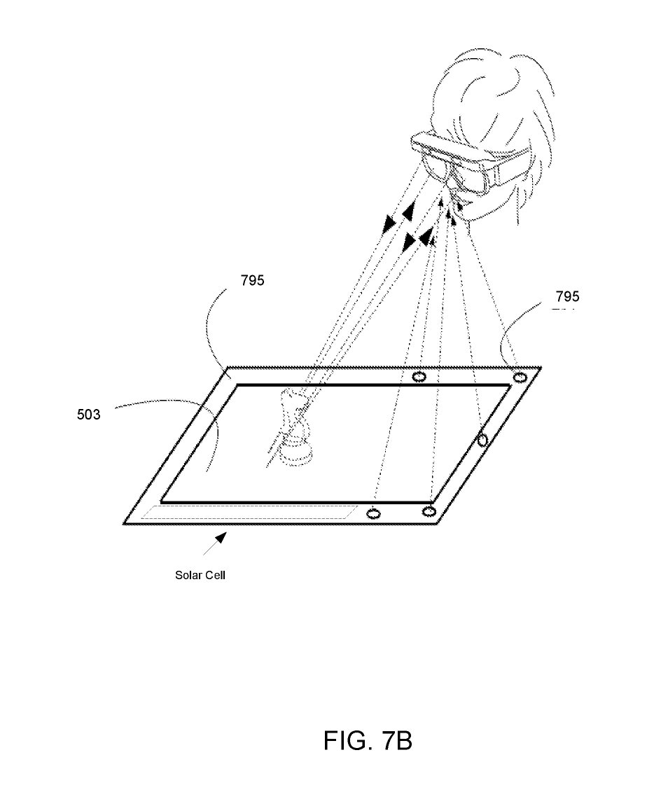

FIG. 7A illustrates an alternate embodiment having fiducial markers that are active emitters. However, in this embodiment energy harvesting is performed to acquire energy to power the active fiducial markers 795. For example, an electromagnetic antenna may be integrated in the border region 795 or in the body of the retroreflective screen. The electromagnetic antenna may, for example, acquire energy from low or high frequency electromagnetic waves. If desired, an additional capacitor or other energy storage device (not illustrated) may be included, if needed to build up power to flash the active emitters. FIG. 7B shows another alternate embodiment in which a solar cell is integrated into the border regions to provide power for active fiducials.

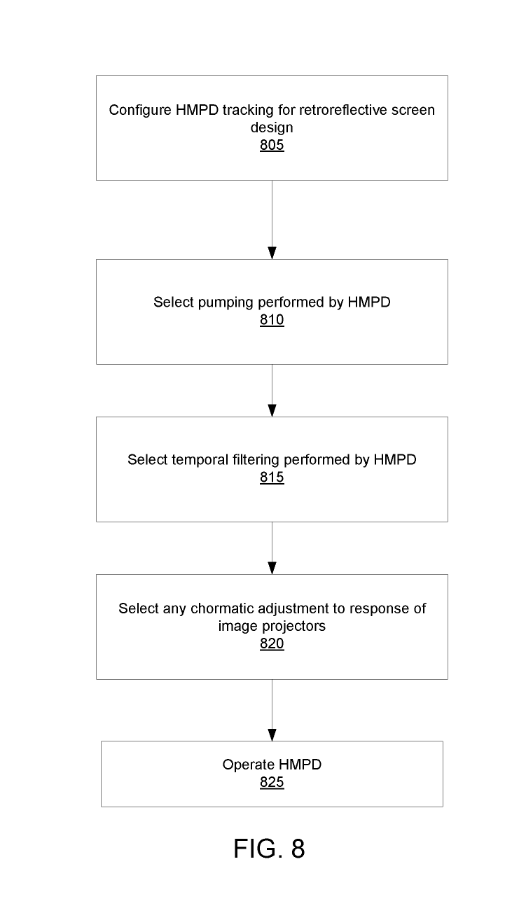

FIG. 8 illustrate a method of operating a HMPD in accordance with an embodiment. As previously discussed, in the most general case a HMPD may be designed to operate with more than one design of a retroreflective screen having integrated fiducials. In one embodiment, a HMPD is configured 805 to perform HMPD motion tracking for a particular design of a retroreflective screen having integrated fiducials. A decision is made whether any pumping is performed 810 by the HMPD. A decision is made to select any temporal filtering by the HMPD 815. A selection is made to select any chromatic adjustments to the image projectors 820. The HMPD is then operated 825.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or computing devices. In addition, those of ordinary skill in the art will recognize that devices such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. An augmented reality projected image game system, comprising:
a head mounted projected display including at least one image projector to project images and a tracking module to track the position of said head mounted display based at least in part on detecting fiducial markers;
a game mat having a retroreflective game area for the return of projected images to said head mounted projected display;
said retroreflective mat having a plurality of fiducial markers integrated into said game mat for optical tracking by said tracking module of said head mounted projected display.

2. The system of claim 1, wherein said fiducial markers comprise fluorescent markers.

3. The system of claim 2, wherein and said head mounted projected display further comprises an illumination source to generate light at a frequency to pump said fluorescent markers.

4. The system of claim 3, wherein said illumination source pumps said fiducial markers at an infrared wavelength shorter than an emission wavelength of said fiducial markers.

5. The system of claim 3, wherein said illumination source pumps said fiducial markers at an infrared wavelength longer than an emission wavelength of said fiducial markers.

6. The system of claim 3, wherein said illumination source emits a sequence of pumping pulses and said tracking module samples the state of said fiducial markers during time intervals when there is no pumping and said fiducial markers are fluorescing.

7. The system of claim 3, wherein a pump wavelength is offset from the emission wavelength of said fiducial markers and spectral filtering is performed at said head mounted projection display to filter out reflected pump illumination.

8. The system of claim 1, wherein said plurality of fiducial markers comprise markers disposed on a border region of said game mat.

9. The system of claim 1, wherein said plurality of fiducial markers comprise a spatial variation in absorption of a non-visible wavelength band over two-dimensional sub-regions of said retroreflective game area of said game mat.

10. The system of claim 9, wherein said head mounted projection display adapts a spectral response of said image projectors to adapt to a visible wavelength response of said retroreflective game area.

11. A projected image returning surface comprising:
a retroreflective central area for the return of projected images to a head mounted projected display; and
a border area adjacent to said central area containing a plurality of fiducial markers arranged for the optical tracking of said head mounted projected display.

12. The surface of claim 11 in which said fiducial markers in said border area are formed as retroreflective markers on a nonretroreflective background or are formed as nonretroreflective markers on a retroreflective background.

13. The surface of claim 12 in which said retroreflective markers are covered with lenses or light filtering elements.

14. A projected image returning surface comprising:
a retroreflective area for the return of projected images to a head mounted projected display;
said retroreflective area containing a plurality of fiducial markers arranged for the optical tracking of said head mounted projected display, with the fiducial markers formed to not be visible in the returned projected images.

15. The surface of claim 14 in which said fiducial markers comprise a spatial variation in an optical characteristic of said retroreflective area in at least one non-visible wavelength band of light.

16. The surface of claim 15 in which said fiducial markers match background surface retroreflectivity in visible wavelengths of light, but not in either selected ultraviolet wavelength bands or selected infrared wavelength bands, or both.

17. The surface of claim 16, comprising one or more lamination layers selectively containing ultraviolet or infrared absorbing dyes that are otherwise transparent to visible light.

18. The surface of claim 16, wherein a visible dye or dyes is applied to the general surface that is not marked, so as to match any unwanted visible absorption by the fiducial marking dye or dyes.

19. The surface of claim 16, wherein one or more lamination layers are selectively thinned so as to provide diffractive interference at a specified wavelength.

20. The surface of claim 16, comprising interference coatings on microspheres are selectively placed on the surface.

21. The surface of claim 16 comprising different diffraction patterns placed upon or molded into an otherwise retroreflective surface.

22. The surface of claim 16 wherein said fiducial markers filter reflect ultraviolet and/or infrared light by polarization.

23. An augmented reality projected image game system, comprising:
a head mounted projected display including at least one image projector to project images and a tracking module to track the position of said head mounted display based at least in part on detecting fiducial markers;
a game mat having a retroreflective game area for the return of projected images to said head mounted projected display; and
said game mat having a plurality of fiducial markers integrated into said retroreflective game area for optical tracking by said tracking module of said head mounted projected display;
wherein said plurality of fiducial markers are configured to not interfere with retroreflection of visible light in said retroreflective game area; and
wherein said plurality of fiducial markers are powered by said retroreflective mat harvesting energy from at least one energy source from the group consisting of: ambient light, illumination by said head mounted projected display, and an antenna collecting electromagnetic energy.

24. The game system of claim 23, wherein said fiducial markers are disposed in a boundary region of said retroreflective mat.

25. The game system of claim 23, wherein said fiducial marking are disposed in said retroreflective game area and comprise a spatial variation in an optical response in a non-visible wavelength band of light over two-dimensional sub-regions of said retroreflective game area.
